(19) United States
(12) Patent Application Publication
(10) Pub. No.: US 2011/0217538 A1
(43) Pub. Date: Sep. 8, 2011

(54) THERMOPLASTIC ELASTOMER COMPOSITION, FOAM BODY AND LAMINATED BODY

(75) Inventors: Yu MIURA, Chiba (JP); Yuya YAMAMOTO, Chiba (JP)

(73) Assignee: SUMITOMO CHEMICAL COMPANY, LIMITED, Tokyo (JP)

(21) Appl. No.: 13/038,947

(22) Filed: Mar. 2, 2011

(30) Foreign Application Priority Data
Mar. 5, 2010 (JP) 2010-048799

(51) Int. Cl. B32B 3/26; C08L 53/02; B32B 27/32

(52) U.S. Cl. 428/304.4; 524/505; 521/139; 428/521

(57) ABSTRACT

A thermoplastic elastomer composition for injection molding is provided that includes component (A), component (B), component (C) and component (D) below, relative to 100 parts by weight of component (A), component (B) having a content of 5 to 150 parts by weight, component (C) having a content of 5 to 300 parts by weight, and component (D) having a content of 5 to 150 parts by weight. (A): A hydrogenated product of a block copolymer composed of a block (a) composed of an aromatic vinyl compound-based monomer unit, and a block (b) composed of a conjugated diene compound-based monomer unit, having a 1,2-bond content of not less than 60%, (B): a propylene-based resin, (C): a mineral oil softener, and (D): an ethylene-propylene copolymer rubber having a Mooney viscosity (ML₁₊₄, 100° C.) of 20 to 200, an ethylene-based monomer unit having a content of 40 to 80 wt % (relative to 100 wt % of the copolymer rubber). There are also provided a foam body formed by foam injection molding of the thermoplastic elastomer composition, and a laminated body composed of a layer formed by molding the thermoplastic elastomer composition and a layer formed by molding a thermoplastic resin.

### BACKGROUND OF THE INVENTION

1. Field of the Invention

The present invention relates to a thermoplastic elastomer composition, a foam body and a laminated body.

2. Description of Related Art

Foam bodies used in automobile, interior materials, household electrical appliances, furniture, etc. are required to have flexibility, heat resistance, etc., and as such a foam body, a foam body formed by foam injection molding a styrenic thermoplastic elastomer composition comprising a polypropylene-based resin and a hydrogenated product of a block copolymer comprising a block composed of an aromatic vinyl compound-based monomer unit and a block composed of a conjugated diene compound-based monomer unit has been examined.

For example, JP-A-2009-161740 (JP-A denotes a Japanese unexamined patent application publication) proposes a foam body produced by foam injection molding a thermoplastic elastomer composition containing a hydrogenated product of a block copolymer containing an aromatic vinyl compound block and a conjugated diene compound block, a propylene-based resin, a mineral oil softener, and an elastomer composition of a ethylene-propylene copolymer.

### SUMMARY OF THE INVENTION

However, in the above-mentioned foam body, the foam body might be deformed or production efficiency might be lowered by a mold release failure after a foam injection molding, and there is a room for improvement in point of mold-releasing properties. In the light of such circumstances, it is an object of the present invention to provide a thermoplastic elastomer composition that exhibits good mold-releasing properties after the foam injection molding, is excellent in the fineness and uniformity of foamed cells and has a good adherence with thermoplastic resin layer when a laminated body is formed, a foam body by foam injection molding the thermoplastic elastomer composition, and a laminated body.

### MEANS FOR SOLVING THE PROBLEMS

A first aspect of the present invention relates to a thermoplastic elastomer composition for injection molding, the composition comprising component (A), component (B), component (C) and component (D) below, component (B) having a content of 5 to 150 parts by weight, component (C) having a content of 5 to 300 parts by weight, and component (D) having a content of 5 to 150 parts by weight relative to 100 parts by weight of component (A), (A): a hydrogenated product of a block copolymer comprising a block (a) composed of an aromatic vinyl compound-based monomer unit, and a block (b) composed of a conjugated diene compound-based monomer unit, having a 1,2-bond content of not less than 60%, (B): a propylene-based resin, (C): a mineral oil softener, and (D): an ethylene-propylene copolymer rubber having a Mooney viscosity (ML₁₊₄, 100° C.) of 20 to 200, an ethylene-based monomer unit having a content of 40 to 80 wt % (relative to 100 wt % of the copolymer rubber).

A second embodiment of the present invention relates to a foam body produced by foam injection molding the above-mentioned thermoplastic elastomer composition.

A third embodiment of the present invention relates to a laminated body composed of a layer formed by molding the above-mentioned thermoplastic elastomer composition (also called “a thermoplastic elastomer composition layer”) and a layer formed by molding a thermoplastic resin (thermoplastic resin layer).

### DETAILED DESCRIPTION OF THE INVENTION

The thermoplastic elastomer composition for foam injection molding of the present invention contains component (A), component (B), component (C) and component (D) below,

(A): a hydrogenated product of a block copolymer comprising a block (a) composed of an aromatic vinyl compound-based monomer unit, and a block
(b) composed of a conjugated diene compound-based monomer unit, having a 1,2-bond content of not less than 60%,
(B): a propylene-based resin,
(C): a mineral oil softener, and
(D): an ethylene-propylene copolymer rubber having a Mooney viscosity (ML₁₊₄, 100° C.) of 20 to 200, an ethylene-based monomer unit having a content of 40 to 80 wt % (relative to 100 wt % of the copolymer rubber).

Component (A) used in the present invention is a compound formed by hydrogenating a block copolymer comprising a block (a) composed of an aromatic vinyl compound-based monomer unit (aromatic vinyl compound block) and a block (b) composed of a conjugated diene compound-based monomer unit (conjugated diene compound block). Examples of the aromatic vinyl compound include styrene, α-methylstyrene, o-methylstyrene, m-methylstyrene, p-methylstyrene, 1,3-dimethylstyrene, vinylnaphthalene, and vinylanthracene, and styrene is preferable. With regard to these aromatic vinyl compounds, two or more types thereof may be used. Furthermore, examples of the conjugated diene compound include butadiene, isoprene, 1,3-pentadiene, and 2,3-dimethyl-1,3-butadiene, and butadiene and isoprene are preferable. With regard to these conjugated diene compounds, two or more types thereof may be used.

With regard to the content of the aromatic vinyl compound block and the conjugated diene compound block, from the viewpoint of enhancing the mechanical strength and the heat resistance of a foam body it is preferable for the content of the aromatic vinyl compound block to be not less than 5 wt % and for the content of the conjugated diene compound block to be not more than 95 wt %, and it is more preferable for the content of the aromatic vinyl compound block to be not less than 10 wt % and for the content of the conjugated diene compound block to be not more than 90 wt %. Furthermore, from the viewpoint of enhancing the flexibility of a foam body, it is preferable for the content of the aromatic vinyl compound block to be not more than 50 wt % and for the content of the conjugated diene compound block to be not less than 50 wt %, and it is more preferable for the content of the aromatic vinyl compound block to be not more than 40 wt % and for the content of the conjugated diene compound block to be not less than 60 wt %. Here, the total amount of aromatic vinyl compound block and conjugated diene compound block is defined as 100 wt %.

The above-mentioned block copolymer may be a diblock copolymer having an aromatic vinyl compound block-conjugated diene compound block structure, or may be a triblock copolymer such as an aromatic vinyl compound block-conjugated diene compound block-aromatic vinyl compound block structure etc. The conjugated diene monomer in the block copolymer has such a bond system that the ratio of a 1,2-bond occupying in the whole bond system of conjugated diene monomer is not less than 60%, and preferably from not less than 65% to not more than 95%.

Meanwhile, the bond system of the conjugated diene monomer can be checked by an infrared spectrometer or NMR.

The hydrogenated product of the block copolymer is one formed by partially or completely hydrogenating the double bonds of a conjugated diene compound-based monomer unit forming the conjugated diene compound block. From the viewpoint of enhancing the weatherability and the heat resistance of a foam body, the degree of hydrogenation, that is, with the amount of double bonds of the conjugated diene compound-based monomer unit of the block copolymer prior to hydrogenation as 100%, among the double bonds the amount of double bonds that are hydrogenated by hydrogenation of the block copolymer, is preferably not less than 50%, more preferably not less than 80%.

From the viewpoint of enhancing the fineness of foamed cells and the uniformity of foamed cells, the weight-average molecular weight of the hydrogenated product is not more than 250,000, preferably not more than 220,000. Furthermore, from the viewpoint of enhancing the mechanical strength of the foam body, it is preferably not less than 50,000, more preferably not less than 70,000, yet more preferably not less than 90,000. The weight-average molecular weight is a weight-average molecular weight on a polystyrene basis, and is measured by a gel permeation chromatographic (GPC) method.

As an example of a process for producing the hydrogenated product, a block copolymer is produced by a method described in, for example, JP-B-40-23798 (JP-B denotes a Japanese examined patent application publication), and the block copolymer is then hydrogenated by a method described in, for example, JP-B-42-8704, JP-B-43-6636, JP-A-59-133203, or JP-A-60-79005.

A commercial product may be used as the hydrogenated product. Examples thereof include ‘KRATON-G’ (trade name) manufactured by Kraton Polymers LLC, ‘SEPTON’ (trade name) manufactured by Kuraray Co., Ltd., and ‘Tuftec’ (trade name) manufactured by Asahi Kasei Chemicals Corporation.

Component (B) used in the present invention is a propylene-based resin, and examples thereof include a propylene homopolymer, and a copolymer of propylene and at least one type of comonomer selected from the comonomer group consisting of ethylene and an α-olefin having 4 to 10 carbons. The copolymer may be a random copolymer or a block copolymer. Specific examples of the copolymer include a propylene-ethylene copolymer, a propylene-1-butene copolymer, a propylene-1-hexene copolymer, a propylene-1-octene copolymer, a propylene-ethylene-1-butene copolymer, and a propylene-ethylene-1-hexene copolymer. Preferred propylene-based resins include a propylene homopolymer, a propylene-ethylene copolymer, and a propylene-1-butene copolymer.

The content of the propylene-based monomer unit (propylene unit) of a polymer used as the propylene-based resin is preferably more than 60 wt %, more preferably not less than 80 wt %. Here, the polymer is defined as 100 wt %.

The melt flow rate of the propylene-based resin is preferably 0.1 to 300 g/10 minutes, more preferably 0.5 to 200 g/10 minutes, and yet more preferably 1 to 150 g/10 minutes. The melt flow rate is measured in accordance with JIS K7210 (ASTM D 1238) with a load of 21.18 N at a temperature of 230° C.

The propylene-based resin may be produced by a known polymerization method using as a polymerization catalyst a Ziegler-Natta catalyst, a metallocene catalyst, etc. Examples of the polymerization method include a solution polymerization method, a bulk polymerization method, a slurry polymerization method, and a gas-phase polymerization method, and they may be employed in a combination of two or more types.

Component (C) used in the present invention is a mineral oil softener. Examples thereof include aromatic mineral oils, naphthenic mineral oils and paraffinic mineral oils. Among them, paraffinic mineral oils are preferable. Furthermore, they preferably have an average molecular weight of 300 to 1,500 and pour point of not more than 0° C.

Component (D) used in the present invention is an ethylene-propylene copolymer rubber, that is, a rubber polymer having an ethylene-based monomer unit (ethylene unit) and a propylene-based monomer unit (propylene unit). The ethylene-propylene copolymer rubber may comprise, as a monomer unit other than an ethylene unit and a propylene unit, for example, a monomer unit based on a non-conjugated diene such as 1,4-hexadiene, dicyclopentadiene, or 5-ethylidene-2-norbornene in a range that does not impair the effect of the present invention.

From the viewpoint of enhancing the fineness of foamed cells, the uniformity of foamed cells, and the mechanical strength of the foam body, the Mooney viscosity (ML₁₊₄ 100° C.) of the ethylene-propylene copolymer rubber at 100° C. is not less than 20, preferably not less than 30, more preferably not less than 40, and yet more preferably not less than 50. Furthermore, from the viewpoint of enhancing the molding processability, it is not more than 200, preferably not more than 160, and yet more preferably not more than 150. The Mooney viscosity is measured in accordance with JIS K6300.

From the viewpoint of enhancing the fineness of foamed cells, the uniformity of foamed cells, the mechanical strength of the foam body, and the stability toward heat, oxygen, and light, the content of the ethylene unit of the ethylene-propylene copolymer rubber is not less than 40 wt %, preferably not less than 50 wt %, more preferably not less than 55 wt %, and yet more preferably not less than 60 wt %. Furthermore, the content of the ethylene unit is preferably not more than 80 wt %. Here, the ethylene-propylene copolymer rubber is defined as 100 wt %.

The ethylene-propylene copolymer rubber is produced by a known polymerization method employing an olefin polymerization catalyst. Examples thereof include a slurry polymerization method, a solution polymerization method, a bulk polymerization method, and a gas-phase polymerization method, these methods employing a complex catalyst such as a Ziegler-Natta catalyst, a metallocene catalyst, or a non-metallocene complex.

The thermoplastic elastomer composition of the present invention may comprise various types of additives in a range that does not impair the object of the present invention. Specific examples of the additives include various types of antioxidants such as a phenol-based antioxidant, a phosphorus-based antioxidant, and a sulfur-based antioxidant; various types of thermal stabilizers such as a hindered amine-based thermal stabilizer; various types of UV absorbers such as a benzophenone-based UV absorber, a benzotriazole-based UV absorber, and a benzoate-based UV absorber; various types of antistatic agents such as a nonionic antistatic agent, a cationic antistatic agent, and an anionic antistatic agent; various types of dispersants such as a bisamide-based dispersant, a wax-based dispersant, and an organometallic salt-based dispersant; various types of chlorine scavengers such as a carboxylic acid alkaline earth metal salt-based chlorine scavenger; various types of lubricants such as an amide-based lubricant, a wax-based lubricant, an organometallic salt-based lubricant, and an ester-based lubricant; various types of decomposition agents such as an oxide-based decomposition agent and a hydrotalcite-based decomposition agent; various types of metal deactivators such as a hydrazine-based metal deactivator and an amine-based metal deactivator; various types of flame retardants such as a bromine-containing organic flame retardant, a phosphoric acid-based flame retardant, antimony trioxide, magnesium hydroxide, and red phosphorus; various types of inorganic fillers such as talc, mica, clay, calcium carbonate, aluminum hydroxide, magnesium hydroxide, barium sulfate, glass fiber, carbon fiber, silica, calcium silicate, potassium titanate, and wallastonite; organic fillers; organic pigments; inorganic pigments; inorganic antimicrobial agents; organic antimicrobial agents, and nucleating agent.

From the viewpoint of enhancing the heat resistance of a foam body, the amount of propylene-based resin, which is component (B), combined in the thermoplastic elastomer composition of the present invention is not less than 5 parts by weight, preferably not less than 10 parts by weight, more preferably not less than 20 parts by weight, and yet more preferably not less than 40 parts by weight, relative to 100 parts by weight of component (A). Furthermore, from the viewpoint of enhancing the flexibility of a foam body, it is not more than 150 parts by weight, preferably not more than 120 parts by weight, more preferably not more than 100 parts by weight, and yet more preferably not more than 80 parts by weight.

From the viewpoint of enhancing the molding processability and the flexibility of a foam body, the amount of mineral oil softener, which is component (C), combined in the thermoplastic elastomer composition of the present invention relative to 100 parts by weight of component (A) is not less than 5 parts by weight, preferably not less than 30 parts by weight, and yet more preferably not less than 50 parts by weight. Furthermore, from the viewpoint of enhancing the bleed resistance and the heat resistance of a foam body, it is not more than 300 parts by weight, preferably not more than 250 parts by weight, more preferably not more than 200 parts by weight, yet more preferably not more than 150 parts by weight, and particulary preferably not more than 100 parts by weight.

The thermoplastic elastomer composition of the present invention has the content of component (D) ethylene-propylene copolymer rubber of not less than 5 parts by weight per 100 parts by weight of component (A), preferably not less than 10 parts by weight, yet preferably not less than 20 parts by weight, and particularly preferably not less than 40 parts by weight from the viewpoint of enhancing the fineness of foamed cells, the uniformity of foamed cells, and the heat resistance. Furthermore the content is not more than 150 parts by weight, preferably not more than 130 parts by weight, more preferably not more than 100 parts by weight, and yet more preferably not more than 80 parts by weight from the viewpoint of enhancing the molding processability.

From the viewpoint of tactile impression of the molding, the spring-type hardness (A shape) of the thermoplastic elastomer composition of the present invention is preferably not more than 85, more preferably not more than 83, and yet preferably not more than 80. The lower limit of the spring-type hardness (A shape) is not particularly restricted, but is preferably not less than 20. The spring-type hardness (A shape) is measured in accordance with JIS-K7215 (ASTM D 2240).

From the viewpoint of enhancing the molding processability, the melt flow rate of the thermoplastic elastomer composition of the present invention at 230° C. is preferably 1 to 400 g/10 min, more preferably 2 to 20 g/10 min, and yet preferably 5 to 100 g/10 min. The melt flow rate is measured with a weight of 2.16 kg in accordance with JIS-K7210 (ASTM D 1238-04).

From the viewpoint of maintaining the shape of the molding, the tensile strength (TB) of the thermoplastic elastomer composition of the present invention is preferably 1.0 to 40 MPa, more preferably 2.0 to 20 MPa, and yet preferably 4.0 to 10 MPa. Furthermore, the extension at breaking (EB) of the thermoplastic elastomer composition of the present invention is preferably 100 to 2,000%, more preferably 200 to 1,800%, and yet preferably 300 to 1,500%. Meanwhile, the above-mentioned TB and EB are measured by pulling a dumbbell No. 3 specimen formed from a press sheet having a thickness of 2 mm at a rate of 200 m/min in accordance with JIS-K-6251.

The thermoplastic elastomer composition of the present invention is obtained by melt-kneading the hydrogenated product of component (A), the propylene-based resin of component (B), the mineral oil softener of component (C), the ethylene-propylene copolymer rubber of component (D), and another component such as an additive combined as required using a known thermal kneader such as a mixing roll, a kneader, a Banbury mixer, or an extruder.

Moreover, when combining the mineral oil softener, an oil-extended ethylene-propylene copolymer rubber in which a mineral oil softener is added to an ethylene-propylene copolymer rubber in advance may be used. As a method for combining a mineral oil softener with an ethylene-propylene copolymer rubber, there can be cited as examples (1) a method in which an ethylene-propylene copolymer rubber and a mineral oil softener are mechanically kneaded using a kneading machine such as a roll or a Banbury mixer, and (2) a method in which a mineral oil softener is added to a solution of an ethylene-propylene copolymer rubber, and solvent is subsequently removed by a method such as stream stripping.

The thermoplastic elastomer composition of the present invention is used in foam injection molding and molded into a foam body. In foam injection molding, a cavity of a mold of an injection molding device is filled with a molten thermoplastic elastomer composition having a foaming agent dissolved therein, the molten thermoplastic elastomer composition is foamed within the mold, and the molten thermoplastic elastomer composition is subsequently cooled and solidified, thus giving a foamed molding.

With regard to the foaming agent used in foam injection molding, a known agent such as a chemical foaming agent or a physical foaming agent may be used. With regard to the chemical foaming agent or the physical foaming agent, two or more types thereof may be used in combination. Furthermore, a chemical foaming agent and a physical foaming agent may be used in combination.

Examples of the chemical foaming agent include an inorganic compound and an organic compound, and they may be used in a combination of two or more types. Examples of the inorganic compound include a hydrogen carbonate salt such as sodium hydrogen carbonate, and ammonium carbonate.

Furthermore, examples of the organic compound include a polycarboxylic acid, an azo compound, a sulfone hydrazide compound, a nitroso compound, p-toluenesulfonyl semicarbazide, and an isocyanate compound. Examples of the polycarboxylic acid include citric acid, oxalic acid, fumaric acid, and phthalic acid. Examples of the azo compound include azodicarbonamide (ADCA). Examples of the sulfone hydrazide compound include p-methylurethane benzenesulfonyl hydrazide, 2,4-toluenedisulfonyl hydrazide, and 4,4′-oxybisbenzenesulfonyl hydrazide. Examples of the nitroso compound include dinitrosopentamethylenetetramine (DPT).

Examples of the physical foaming agent include an inert gas and a volatile organic compound such as butane or pentane. As the physical foaming agent, an inert gas is preferable, and examples of the inert gas include carbon dioxide, nitrogen, argon, neon, and helium. Carbon dioxide and nitrogen are more preferable.

The amount of foaming agent used, relative to 100 parts by weight of the thermoplastic elastomer composition, is preferably 0.05 to 20 parts by weight, and more preferably 0.2 to 8 parts by weight.

As an injection method in foam injection molding, there can be cited as examples a single screw injection method, a multiple screw injection method, a high pressure injection method, a low pressure injection method, and an injection method using a plunger, etc. Furthermore, as an injection method, a method in which an inert gas, which is used as a physical foaming agent, is poured into a cylinder of an injection molding device in a supercritical state is preferable.

As a foaming method in foam injection molding, methods (1), (2), and (3) below can be cited as examples.

(1) A method in which an amount of foaming agent-containing molten thermoplastic elastomer composition that is smaller than the volume of a mold cavity is injected into the mold cavity, and the mold cavity is filled with the molten thermoplastic elastomer composition due to expansion of gas from the foaming agent, thus carrying out foaming.
(2) A method in which an amount of foaming agent-containing molten thermoplastic elastomer composition that fully fills the mold cavity with the foaming agent-containing molten thermoplastic elastomer composition is injected into the mold cavity, and expansion by a portion corresponding to the shrinkage volume of the thermoplastic elastomer composition accompanying cooling is carried out by means of gas from the foaming agent, thus carrying out foaming.
(3) A method in which an amount of foaming agent-containing molten thermoplastic elastomer composition that fully fills the mold cavity with the foaming agent-containing molten thermoplastic elastomer composition is injected into the mold cavity, and a cavity wall face of the mold is subsequently moved back to thus increase the cavity volume, thus making gas from the foaming agent expand and carrying out foaming.

As the foaming method in foam injection molding, a method in which an amount of foaming agent-containing molten thermoplastic elastomer composition that fully fills the mold cavity with the foaming agent-containing molten thermoplastic elastomer composition is injected into the mold cavity (fully-filled method) is preferable.

The foam injection molding may be carried out in a combination with a molding method such as gas-assist molding, melt core molding, insert molding, core back molding, or two-color molding. In particular, by injection molding the thermoplastic elastomer composition of the present invention in such a state that a thermoplastic resin layer is disposed on the back side (insert molding, two-color molding), it is possible to form a laminated body composed of the thermoplastic resin layer and the thermoplastic elastomer composition layer. As the thermoplastic elastomer composition layer, the thermoplastic elastomer composition may be foam molded.

The thermoplastic elastomer composition layer may have a thickness of preferably 0.5 mm to 10 mm, and more preferably 1 mm to 8 mm, in accordance with a foam expansion ratio. Furthermore, in order to prevent the deformation etc. of the laminated body, the thermoplastic resin layer may have a thickness of preferably 1 to 4 mm, and more preferably 1.5 mm to 3 mm.

In the insert molding method, a laminated body, in which a thermoplastic resin layer formed from a thermoplastic resin adheres closely to a thermoplastic elastomer composition layer formed from the thermoplastic elastomer composition of the present invention, can be obtained by previously molding a thermoplastic resin to be a thermoplastic resin layer and, after placing it in an injection molding mold, injection molding the thermoplastic elastomer composition of the present invention.

In the two-color molding method, the laminated body, in which a thermoplastic resin layer formed from a thermoplastic resin adheres closely to a thermoplastic elastomer composition layer formed from the thermoplastic elastomer composition of the present invention, can be obtained by injecting a thermoplastic resin to be a thermoplastic resin layer and, subsequently, injecting the resin composition of the present invention.

With regard to the thermoplastic resin used as the above-mentioned thermoplastic resin layer, various resins may be used, but the use of a propylene-based resin is favorable. Examples of the propylene-based resins include a propylene homopolymer, a propylene-α-olefin random copolymer, a propylene-ethylene block copolymer etc. These resins may be used singly or in a mixture.

Furthermore, various inorganic fillers may be mixed and used with these thermoplastic resin. Examples of the inorganic fillers include talc, calcium carbonate, mica, barium sulfate, barium silicate, clay, magnesium carbonate, alumina, silica, glass fiber reinforcing material, etc.

A foamed molding and a laminated body obtained using the thermoplastic elastomer composition of the present invention has excellent fineness of foamed cells and excellent uniformity of foamed cells. Because of this, a foam body has an excellent feel of softness, and is excellent in terms of light weight, rigidity, and impact resistance.

A foamed molding and a laminated body obtained using the thermoplastic elastomer composition of the present invention is suitably used in automobile interior materials, household electrical appliances, furniture, etc.

By the present invention, it is possible to provide a thermoplastic elastomer composition that exhibits good mold-releasing properties after a foam injection molding, is excellent in the fineness and uniformity of foamed cells and has a good adherence with a thermoplastic resin layer when a laminated body is formed, a foam body produced by foam injection molding the thermoplastic elastomer composition, and a laminated body.

### EXAMPLES

The present invention is explained in more detail below by reference to Examples and Comparative Examples.

### I. Methods for Measuring Physical Properties

### (1) Weight-Average Molecular Weight

Measured using a gel permeation chromatographic (GPC) method under conditions (1) to (8) below.

(1) Device: Waters 150C manufactured by Waters

(2) Separation column: TOSOH TSK gel GMH6-HT

(3) Measurement temperature: 140° C.

(4) Carrier: ortho-dichlorobenzene

(5) Flow rate: 1.0 mL/min

(6) Amount injected: 500 μL

(7) Detector: differential refractometer

(8) Molecular weight reference material: standard polystyrene

### (2) Melt Flow Rate (MFR)

Measured in accordance with JIS K7210 (ASTM D 1238-04) with a load of 21.18 N at a temperature of 230° C.

### (3) Mooney Viscosity (ML₁₊₄, 100° C.)

Measured in accordance with JIS K6300 at a test temperature of 100° C.

### (4) Ethylene Content

Measured by an infrared spectroscopic method.

### (5) Spring-Type Hardness (A Shape) (A Hardness)

It was measured in accordance with JIS-K7215 (ASTM D 2240).

### (6) Tensile Test

The tensile strength (TB) and the extension at breaking (EB) were measured for a dumbbell No. 3 test piece formed from a press sheet having a thickness of 2 mm under a pulling rate condition of 200 mm/min in accordance with JIS-K-6251.

### (II) Processing Properties

(7) Test of Mold-Releasing Properties after Injection Molding

Foam injection molding was carried out using an ES2550/400HL-MuCell (mold clamp force 400 t) manufactured by ENGEL as an injection molding machine with a mold having a box shape with molding dimensions of 290 mm×370 mm, height 45 mm, thickness 1.5 mm (gate structure: bubble gate, molding central portion). 100 parts by weight of the thermoplastic elastomer composition pellets combined with 1 part by weight of an organic acid salt-based foaming agent master batch (MB3083 (trade name) manufactured by Sankyo Kasei Co., Ltd.) as a chemical foaming agent was supplied to the injection molding machine and melted within a cylinder of the injection molding machine, and carbon dioxide was pressurized to 6 MPa and supplied into the cylinder (amount of carbon dioxide injected: 0.6 parts by weight per 100 parts by weight of the thermoplastic elastomer composition). Subsequently, the thermoplastic elastomer composition and the foaming agent were injected at a molding temperature of 210° C. and a mold temperature of 20° C. for an injection time of 2.6 sec to thereby fully fill the cavity of the mold therewith, and they were cooled within the mold cavity. Subsequently, a mold cavity wall face was moved back by 3 mm to thereby increase the inner volume of the cavity, thus carrying out foaming, and cooling and solidification were further carried out, thus giving a foamed molding. The obtained foamed molding was peeled off from the mold and evaluated as follows.

Good: the molding could be peeled off without deformation
Poor: the molding deformed when it was peeled off

### (8) Fineness and Uniformity of Foamed Cells

A foam molding body was sectioned, and the section was examined using a microscope (DG-3 digital field microscope, manufactured by Scalar Corporation), and the fineness and uniformity of foamed cells were evaluated as follows.

### Fineness of Foamed Cells

Good: number-average diameter of cells was not more than 500 μm.
Poor: number-average diameter of cells was more than 500 μm.

### Uniformity of Foamed Cells

Good: size and shape of cells were uniform.
Fair: no open cells were observed, but size and shape of cells were nonuniform.
Poor: open cells were observed, and size and shape of cells were nonuniform.

### (9) Test of Adherence Between the Thermoplastic Elastomer Composition Layer and the Thermoplastic Resin Layer (Adherence Test)

As an injection molding machine, IS100EN-3A (mold clamp force 100 t) manufactured by Toshiba Machine Co., Ltd. with a mold with molding dimensions of 90 mm×150 mm having variable cavity thickness was used. Propylene resin was molded with a cavity initial value of 2 mm at a molding temperature of 200° C. and a mold temperature of 40° C., which was cooled sufficiently and then taken out of the mold to thereby give a foamed molding to be a thermoplastic resin layer. Subsequently, the cavity thickness of the above-mentioned mold was set to be 4 mm, and the thermoplastic resin layer was fixed to a movable mold. After that, the mold was closed, and a thermoplastic elastomer to be a thermoplastic elastomer composition layer was injection molded at a molding temperature of 200° C. and a mold temperature of 40° C. to give a laminated body composed of the thermoplastic elastomer composition layer and the thermoplastic resin layer. In order to check whether or not the obtained laminated body is peeled off at the interface of the thermoplastic elastomer composition layer/thermoplastic resin layer, a cut was made between the thermoplastic elastomer composition layer/thermoplastic resin layer at the corner of the laminated body, the laminated body was fixed, and then a clip was attached to the upper thermoplastic elastomer composition layer and the clip was pulled with a force (50 mm/min) added upward in the direction perpendicular to the face. The adherence was evaluated as follows.

Good: no interfacial peeling occurred.
Poor: interface peeling occurred.

### (III) Starting Materials

### (1) Hydrogenated Product of Styrene-Conjugated Diene-Styrene Block Copolymer

### A-1: Tuftec H1221 (Trade Name) Manufactured by Asahi Kasei Chemicals Corporation

(hydrogenated product of styrene-butadiene-styrene block copolymer, weight-average molecular weight 200,000, styrene unit content 12 wt %, 1,2-bond content of diene unit 74%, degree of hydrogenation 99%)

### A-2: KRATON G1642 (Trade Name) Manufactured by Kraton Polymers LLC

(hydrogenated product of styrene-butadiene-styrene block copolymer, weight-average molecular weight 160,000, styrene unit content 20 wt %, 1,2-bond content of diene unit 69%, degree of hydrogenation 100%)

### A-3: KRATON G1651H (Trade Name) Manufactured by Kraton Polymers LLC

(hydrogenated product of styrene-butadiene-styrene block copolymer, weight-average molecular weight 320,000, styrene unit content 33 wt %, 1,2-bond content of diene unit 39%, degree of hydrogenation 100%)

### A-4: SEPTON 1020 (Trade Name) Manufactured by Kuraray Co., Ltd.

(hydrogenated product of styrene-isoprene block copolymer, weight-average molecular weight 160,000, styrene unit content 36 wt %, 1,2- and 3,4-bond content of diene unit 6%, degree of hydrogenation 99%)

### A-5: SEPTON 2063 (Trade Name) Manufactured by Kuraray Co., Ltd.

(hydrogenated product of styrene-isoprene-styrene block copolymer, weight-average molecular weight 129,000, styrene unit content 13 wt %, 1,2- and 3,4-bond content of diene unit 7%, degree of hydrogenation 100%)

### (2) Propylene-Based Resin

### B-1: NOBRENE HR100EG (Trade Name) Manufactured by Sumitomo Chemical Co., Ltd.

(propylene homopolymer, MFR=19 g/10 min)

### (3) Paraffin-Based Mineral Oil Softener

### C-1: Diana Process Oil PW-100 (Trade Name) Manufactured by Idemitsu Kosan Co., Ltd.

(pour point: −15° C.)

### (4) Ethylene-Propylene Copolymer Rubber

### D-1: Esprene 512P (Trade Name) Manufactured by Sumitomo Chemical Co., Ltd.

(ML₁₊₄, 100° C.=90, ethylene unit content=67 wt %)

### D-2: ENGAGE ENR 6386 (Trade Name) Manufactured by Dow Chemical Company

(ML₁₊₄, 100° C.=44, ethylene unit content=75 wt %)

### D-3: Developed Product 1 Manufactured by Sumitomo Chemical Co., Ltd.

(ML₁₊₄, 100° C.=55, ethylene unit content=68 wt %, extender oil content=50 wt %)

### Example 1

### Preparation of Thermoplastic Elastomer Composition

100 parts by weight (4,080 g) of the hydrogenated product of a styrene-conjugated diene-styrene block copolymer A-1, 65 parts by weight (2,640 g), relative to 100 parts by weight of A-1, of the propylene-based resin B-1, 71 parts by weight (2,880 g), relative to 100 parts by weight of A-1, of the mineral oil softener C-1, 59 parts by weight (2,400 g), relative to 100 parts by weight of A-1, of the ethylene-propylene copolymer rubber D-1, and, relative to 100 parts by weight of the total of A-1, B-1, C-1, and D-1, 0.05 parts by weight (6 g) of erucamide (NEUTRON S (trade name) manufactured by Nippon Fine Chemical), 0.05 parts by weight (6 g) of calcium stearate, 0.10 parts by weight (12 g) of antioxidant IRGANOX 1010 (trade name) manufactured by Ciba Specialties, and 0.05 parts by weight (6 g) of antioxidant Ultranox 626 (trade name) manufactured by GE Specialty Chemicals were melt-kneaded in a 16 L Banbury mixer manufactured by Kobe Steel, Ltd. at a rotation number of 68 rpm and then molded into pellets, thus giving thermoplastic elastomer composition pellets.

### (Production of Injection-Foamed Molding)

Foam injection molding was carried out using an ES2550/400HL-MuCell manufactured by ENGEL as an injection molding machine (mold clamp force 400 t) with a mold having a box shape with molding dimensions of 290 mm×370 mm, height 45 mm, thickness 1.5 mm (gate structure: bubble gate, molding central portion). 100 parts by weight of the thermoplastic elastomer composition pellets combined with 1 part by weight of an organic acid salt-based foaming agent master batch (MB3083 (trade name) manufactured by Sankyo Kasei Co., Ltd.) as a chemical foaming agent was supplied to the injection molding machine and melted within a cylinder of the injection molding machine, and carbon dioxide was pressurized to 6 MPa and supplied into the cylinder (amount of carbon dioxide injected: 0.6 parts by weight relative to 100 parts by weight of the thermoplastic elastomer composition). Subsequently, the thermoplastic elastomer composition and the foaming agent were injected at a molding temperature of 210° C. and a mold temperature of 20° C. for an injection time of 2.6 sec to thereby fully fill the cavity of the mold therewith, and they were cooled within the mold cavity. Subsequently, a mold cavity wall face was moved back by 3 mm to thereby increase the inner volume of the cavity, thus carrying out foaming, and cooling and solidification were further carried out, thus giving a foamed molding. The evaluation results are given in Table 1.

### (Production of Laminated Body)

As an injection molding machine, IS100EN-3A (mold clamp force 100 t) manufactured by Toshiba Machine Co., Ltd. with a mold with molding dimensions of 90 mm×150 mm having variable cavity thickness was used. Propylene resin was molded with a cavity initial thickness of 2 mm at a molding temperature of 200° C. and a mold temperature of 40° C., which was cooled sufficiently and then taken out of the mold, thereby giving a foamed molding to be a thermoplastic resin layer. Subsequently, the cavity thickness of the above-mentioned mold was set to be 4 mm, and the thermoplastic resin layer was fixed to a movable mold. After that, the mold was closed, and a thermoplastic elastomer to be a thermoplastic elastomer composition layer was injection molded at a molding temperature of 200° C. and a mold temperature of 40° C., thereby giving a laminated body composed of the thermoplastic elastomer composition layer (thickness 2 mm) and the thermoplastic resin layer (thickness 2 mm). The evaluation results are given in Table 1.

### Example 2

The procedure of Example 1 was repeated except that a nucleating agent (polypropylene master batch comprising 10 wt % of Gel All D (trade name) manufactured by New Japan Chemical Co., Ltd. and 1.7 wt % of HYPERFORM HPN-68L (trade name) manufactured by Milliken & Company) and calcium carbonate were added as additives. The evaluation results are given in Table 1.

### Example 3

The procedure of Example 1 was repeated except that the hydrogenated product of a styrene-conjugated diene-styrene block copolymer A-2 was used instead of the hydrogenated product of a styrene-conjugated diene-styrene block copolymer A-1. The evaluation results are given in Table 1.

### Example 4

The procedure of Example 1 was repeated except that the ethylene-propylene copolymer rubber D-2 was used instead of the ethylene-propylene copolymer rubber D-1. The evaluation results are given in Table 1.

### Example 5

The procedure of Example 1 was repeated except that the ethylene-propylene copolymer rubber D-3 containing a mineral oil was used instead of the paraffinic mineral oil softener C-1 and the ethylene-propylene copolymer rubber D-1. The evaluation results are given in Table 1.

### Comparative Example 1

The procedure of Example 1 was repeated except that the hydrogenated product of a styrene-conjugated diene-styrene block copolymer A-3 was used instead of the hydrogenated product of a styrene-conjugated diene-styrene block copolymer A-1. The evaluation results are given in Table 2.

### Comparative Example 2

The procedure of Example 1 was repeated except that the hydrogenated product of a styrene-conjugated diene-styrene block copolymer A-4 was used instead of the hydrogenated product of a styrene-conjugated diene-styrene block copolymer A-1. The evaluation results are given in Table 2.

### Comparative Example 3

The procedure of Example 1 was repeated except that the hydrogenated product of a styrene-conjugated diene block copolymer A-5 was used instead of the hydrogenated product of a styrene-conjugated diene-styrene block copolymer A-1. The evaluation results are given in Table 2.

### Comparative Example 4

The procedure of Example 1 was repeated except that the hydrogenated product of a styrene-conjugated diene-styrene block copolymer A-1 was not used. The evaluation results are given in Table 2.

### Comparative Example 5

The procedure of Example 1 was repeated except that the propylene-based resin B-1 was not used. The evaluation results are given in Table 2.

### Comparative Example 6

The procedure of Example 1 was repeated except that the paraffinic mineral oil softener C-1 was not used. The evaluation results are given in Table 2.

### Comparative Example 7

The procedure of Example 1 was repeated except that the ethylene-propylene copolymer rubber D-1 was not used. The evaluation results are given in Table 2.

TABLE 1

| | | Ex. 1 | Ex. 2 | Ex. 3 | Ex. 4 | Ex. 5 |
|---|---|---|---|---|---|---|
| Composition | | | | | | |
| A-1 | Parts by weight | 100 | 100 | — | 100 | 100 |
| A-2 | Parts by weight | — | — | 100 | — | — |
| B-1 | Parts by weight | 65 | 65 | 65 | 65 | 65 |
| C-1 | Parts by weight | 71 | 71 | 71 | 71 | — |
| D-1 | Parts by weight | 59 | 59 | 59 | — | — |
| D-2 | Parts by weight | — | — | — | 59 | — |
| D-3 | Parts by weight | — | — | — | — | 130 |
| Nucleating Agent | Parts by weight | — | 1 | — | — | — |
| Calcium carbonate | Parts by weight | — | 5 | — | — | — |

| | | | | | |
|---|---|---|---|---|---|
| Physical properties | | | | | |
| MFR (g/10 min) | 34 | 33 | 9 | 40 | 12 |
| A hardness | 74 | 77 | 77 | 76 | 80 |
| Tensile strength (TB) (MPa) | 6.4 | 6.1 | 6.5 | 6.8 | 8.7 |
| Extension at breaking (EB) (%) | 630 | 600 | 540 | 710 | 620 |
| Evaluation results of processability | | | | | |
| Mold-releasing properties | Good | Good | Good | Good | Good |
| after injection molding | | | | | |
| Fineness of foamed cells | Good | Good | Good | Good | Good |
| Uniformity of foamed cells | Good | Good | Good | Good | Good |
| Adherence | Good | Good | Good | Good | Good |

TABLE 2

| | | Comp. | Comp. | Comp. | Comp. | Comp. | Comp. | Comp. |
|---|---|---|---|---|---|---|---|---|
| | | Ex. 1 | Ex. 2 | Ex. 3 | Ex. 4 | Ex. 5 | Ex. 6 | Ex. 7 |
| Composition | | | | | | | | |
| A-1 | Parts by weight | — | — | — | — | 100 | 100 | 100 |
| A-3 | Parts by weight | 100 | — | — | — | — | — | — |
| A-4 | Parts by weight | — | 100 | — | — | — | — | — |
| A-5 | Parts by weight | — | — | 100 | — | — | — | — |
| B-1 | Parts by weight | 65 | 65 | 65 | 65 | — | 65 | 65 |
| C-1 | Parts by weight | 71 | 71 | 71 | 71 | 71 | — | 71 |
| D-1 | Parts by weight | 59 | 59 | 59 | 59 | 59 | 59 | — |

| | | | | | | | |
|---|---|---|---|---|---|---|---|
| Physical properties | | | | | | | |
| MFR (g/10 min) | 0.2 | 10 | 25 | 59 | 54 | 4.4 | 170 |
| A hardness | 78 | 68 | 79 | 89 | 26 | 89 | 74 |
| Tensile strength (TB) (MPa) | 13 | 1.6 | 6.0 | 4.3 | 1.1 | 20 | 6.7 |
| Extension at breaking (EB) (%) | 720 | 300 | 590 | 190 | 1130 | 940 | 800 |
| Evaluation results of processability | | | | | | | |
| Mold-releasing properties after | Good | Poor | Poor | Poor | Poor | Good | Good |
| injection molding | | | | | | | |
| Fineness of foamed cells | Poor | Poor | Good | Poor | Poor | Poor | Poor |
| Uniformity of foamed cells | Poor | Poor | Good | Poor | Fair | Fair | Fair |
| Adherence | Good | Poor | Good | Poor | Poor | Good | Poor |

What is claimed is:

1. A thermoplastic elastomer composition for injection molding, the composition comprising component (A), component (B), component (C) and component (D) below, component (B) having a content of 5 to 150 parts by weight, component (C) having a content of 5 to 300 parts by weight, and component (D) having a content of 5 to 150 parts by weight relative to 100 parts by weight of component (A),
(A): a hydrogenated product of a block copolymer comprising a block (a) composed of an aromatic vinyl compound-based monomer unit, and a block
(b) composed of a conjugated diene compound-based monomer unit, having a 1,2-bond content of not less than 60%,
(B): a propylene-based resin,
(C): a mineral oil softener, and
(D): an ethylene-propylene copolymer rubber having a Mooney viscosity
(ML₁₊₄, 100° C.) of 20 to 200, an ethylene-based monomer unit having a content of 40 to 80 wt % (relative to 100 wt % of the copolymer rubber).

2. The thermoplastic elastomer composition according to claim 1, wherein component (A) is the hydrogenated product of a block copolymer having a weight-average molecular weight of not more than 250,000.

3. The thermoplastic elastomer composition according to claim 1, wherein component (B) is a propylene homopolymer having a melt flow rate at 230° C. (JIS-K7210 (ASTM D 1238-04), load 2.16 kg) of 0.1 to 300 g/min.

4. The thermoplastic elastomer composition according to claim 1, wherein component (D) has an ethylene-based monomer unit in a content of 60 to 80 wt %.

5. The thermoplastic elastomer composition according to claim 1, wherein a spring-type hardness (A shape, JIS-K7215 (ASTM D 2240)) is not more than 85.

6. A foam body formed by foam injection molding of the thermoplastic elastomer composition according to claim 1.

7. A laminated body comprising a layer formed by molding the thermoplastic elastomer composition according to claim 1, and a layer formed by molding a thermoplastic resin.

8. The laminated body according to claim 7, wherein the layer formed by molding the thermoplastic elastomer composition is formed by foam injection molding of the thermoplastic elastomer composition.
